(19) United States
(12) Patent Application Publication
(10) Pub. No.: US 2019/0003933 A1
(43) Pub. Date: Jan. 3, 2019

(54) SEPARATION DEVICES FOR BIOLOGICAL SAMPLES

(71) Applicant: BOSTON SCIENTIFIC SCIMED, INC., MAPLE GROVE, MN (US)

(72) Inventors: JEFF GRAY, SUDBURY, MA (US); JOSHUA CLARK, SPENCER, IN (US); SAMUEL RAYBIN, MARLBOROUGH, MA (US); RYAN V. WALES, NORTHBOROUGH, MA (US)

(73) Assignee: BOSTON SCIENTIFIC SCIMED, INC., MAPLE GROVE, MN (US)

(21) Appl. No.: 16/022,003

(22) Filed: Jun. 28, 2018

Related U.S. Application Data
(60) Provisional application No. 62/527,610, filed on Jun. 30, 2017.

(51) Int. Cl. G01N 1/22; G01N 1/14

(52) U.S. Cl. CPC G01N 1/2205; G01N 1/2247; G01N 2035/00475; G01N 1/2226; G01N 1/14

(57) ABSTRACT

Devices for physically separating biological samples and methods for separating biological samples are disclosed. An example device may include a vessel for holding a biological sample. The biological sample may include a plurality of cells and a fluid. A filter membrane may be disposed within the vessel and positioned adjacent to an end region of the vessel. An auger member may be disposed within the vessel. The auger member may be designed to drive cells within the biological sample into contact with the filter membrane.

### CROSS-REFERENCE TO RELATED APPLICATIONS

This application claims priority under 35 U.S.C. § 119 to U.S. Provisional Application Ser. No. 62/527,610, filed Jun. 30, 2017, the entirety of which is incorporated herein by reference.

### TECHNICAL FIELD

The present disclosure pertains to medical devices, and methods for manufacturing medical devices. More particularly, the present disclosure pertains to separation devices for biological samples.

### BACKGROUND

A wide variety of medical devices have been developed for medical use, for example for collecting, separating, and/or processing biological samples. Some of these devices include separation devices.

### BRIEF SUMMARY

An example medical device includes a device for physically separating a biological sample. The device comprises: a vessel for holding a biological sample, the biological sample includes a plurality of cells and a fluid; a filter membrane disposed within the vessel and positioned adjacent to an end region of the vessel; and an auger member disposed within the vessel, the auger member being designed to drive cells within the biological sample into contact with the filter membrane.

An example medical device includes a device for separating a sample. The device comprises: a vessel for holding a sample, the sample includes a plurality of cells; a filter membrane within the vessel and positioned adjacent to an end region of the vessel; and an auger member within the vessel, the auger member designed to place the plurality of cells into contact with the filter membrane.

Alternatively or additionally to any of the embodiments above, the vessel includes an open first end region and a second end region positioned substantially opposite the open first end region.

Alternatively or additionally to any of the embodiments above, further comprising a fluid passageway formed along the second end region.

Alternatively or additionally to any of the embodiments above, at least a portion of the filter membrane is positioned against a bottom end surface of the vessel.

Alternatively or additionally to any of the embodiments above, the filter membrane is spaced from a bottom end surface of the vessel.

Alternatively or additionally to any of the embodiments above, the auger member includes a central shaft and a helical thread disposed about the central shaft.

Alternatively or additionally to any of the embodiments above, the auger member is designed to rotate within the vessel.

Alternatively or additionally to any of the embodiments above, the auger member includes a central shaft and a compression member disposed at an end region of the central shaft, wherein the filter membrane is coupled to the compression member.

A device for physically separating a biological sample is disclosed. The device comprises: a vessel for holding a biological sample, the biological sample includes a plurality of cells and a fluid; a filter membrane disposed within the vessel, the filter membrane having a first end disposed along a bottom wall surface of the vessel and a second end spaced from the bottom wall surface; and a one-way filter disposed within the vessel and positioned adjacent to the second end of the filter membrane, the one-way filter being designed to allow cells within the biological sample to pass therethrough in a first direction and the one-way filter being designed to substantially prevent cells within the biological sample to pass therethrough in a second direction substantially opposite the first direction.

A device for separating a sample is disclosed. The device comprises: a vessel for holding a biological sample, the biological sample includes a plurality of cells; a filter membrane disposed within the vessel, the filter membrane having a first end along a bottom wall surface of the vessel and a second end spaced from the bottom wall surface; and a one-way filter within the vessel and positioned adjacent to the second end of the filter membrane, the one-way filter designed to allow cells within the biological sample to pass therethrough in a first direction and the one-way filter being designed to prevent cells within the sample to pass therethrough in a second direction opposite the first direction.

Alternatively or additionally to any of the embodiments above, the filter membrane is substantially cylindrical.

Alternatively or additionally to any of the embodiments above, an opening is formed in the vessel along the bottom wall surface.

Alternatively or additionally to any of the embodiments above, at least a portion of the filter membrane extends about the opening.

Alternatively or additionally to any of the embodiments above, the filter membrane extends circumferentially about the opening.

Alternatively or additionally to any of the embodiments above, the one-way filter includes a one-way baffle.

Alternatively or additionally to any of the embodiments above, the one-way filter includes a one-way membrane.

Alternatively or additionally to any of the embodiments above, the vessel includes a removable tray region.

Alternatively or additionally to any of the embodiments above, the bottom wall surface is disposed along the removable tray region.

A method for separating a biological sample is disclosed. The method comprises: disposing a biological sample within a centrifuge tube, the biological sample includes a plurality of cells and a fluid; centrifuging the centrifuge tube so that the cells in the biological sample migrate to a bottom wall surface of the centrifuge tube and the fluid within the biological sample is separated from the cells; disposing a barrier member adjacent to the cells along the bottom wall surface to define a physical barrier between the cells and the fluid; and removing the fluid.

Alternatively or additionally to any of the embodiments above, the barrier member comprises a stopcock and wherein disposing a barrier member adjacent to the cells along the bottom wall surface to define a physical barrier between the cells and the fluid includes shifting the stopcock from an open configuration to a closed configuration.

Alternatively or additionally to any of the embodiments above, the barrier member comprises a ball member and wherein disposing a barrier member adjacent to the cells along the bottom wall surface to define a physical barrier between the cells and the fluid includes placing the ball member within the centrifuge tube.

The above summary of some embodiments is not intended to describe each disclosed embodiment or every implementation of the present disclosure. The Figures, and Detailed Description, which follow, more particularly exemplify these embodiments.

### BRIEF DESCRIPTION OF THE DRAWINGS

The disclosure may be more completely understood in consideration of the following detailed description in connection with the accompanying drawings, in which:

FIG. 1 is a side view of an example biological sample separation device.

FIG. 2 is a side view of an example biological sample separation device.

FIG. 3 is a side view of an example biological sample separation device.

FIG. 4 is a side view of an example biological sample separation device.

FIG. 5 is a side view of an example biological sample separation device.

FIG. 6 is a side view of an example biological sample separation device.

FIG. 7 is a side view of an example biological sample separation device.

FIG. 8 is a side view of an example biological sample separation device.

FIG. 9 is a side view of an example biological sample separation device.

FIG. 10 is a side view of an example biological sample separation device.

FIG. 11 is a side view of an example biological sample separation device.

FIG. 12 is a side view of an example biological sample separation device.

FIG. 13 is a side view of an example biological sample separation device.

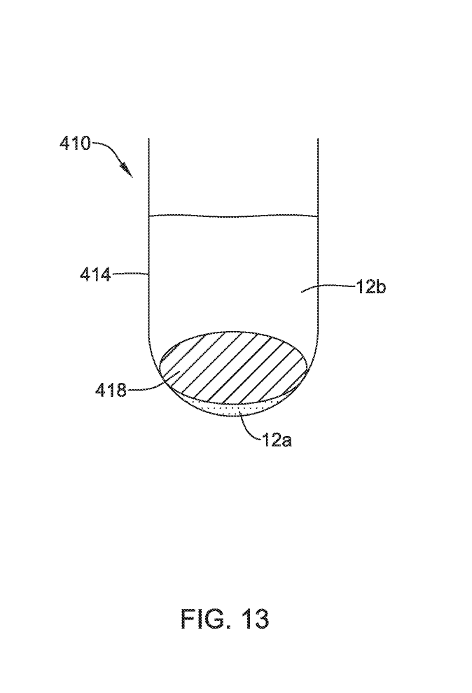

FIG. 14 is a side view of an example biological sample separation device.

FIG. 15 is a side view of an example biological sample separation device.

While the disclosure is amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

For the following defined terms, these definitions shall be applied, unless a different definition is given in the claims or elsewhere in this specification.

All numeric values are herein assumed to be modified by the term “about”, whether or not explicitly indicated. The term “about” generally refers to a range of numbers that one of skill in the art would consider equivalent to the recited value (e.g., having the same function or result). In many instances, the terms “about” may include numbers that are rounded to the nearest significant figure.

The recitation of numerical ranges by endpoints includes all numbers within that range (e.g. 1 to 5 includes 1, 1.5, 2, 2.75, 3, 3.80, 4, and 5).

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include one or more particular features, structures, and/or characteristics. However, such recitations do not necessarily mean that all embodiments include the particular features, structures, and/or characteristics. Additionally, when particular features, structures, and/or characteristics are described in connection with one embodiment, it should be understood that such features, structures, and/or characteristics may also be used connection with other embodiments whether or not explicitly described unless clearly stated to the contrary.

The following detailed description should be read with reference to the drawings in which similar elements in different drawings are numbered the same. The drawings, which are not necessarily to scale, depict illustrative embodiments and are not intended to limit the scope of the disclosure.

There are a number of methods for the collection of biological samples by a biopsy and/or other surgical processes. Such processes typically result in a tissue sample that can be routinely processed for pathological analysis. In some endoscopic procedures such as those where a fine needle aspiration device is utilized, the sample that is collected includes loose cells and fluids. Prior to tissue processing and/or analysis, additional steps may be necessary to gather the desired cells/tissue and allow the cells/tissue to be further processed. Disclosed herein are devices and methods that allow cells/tissue to be efficiently processed and/or analyzed including cells/tissue gathered by fine needle aspiration devices and/or other devices that collect cells/tissue along with fluids.

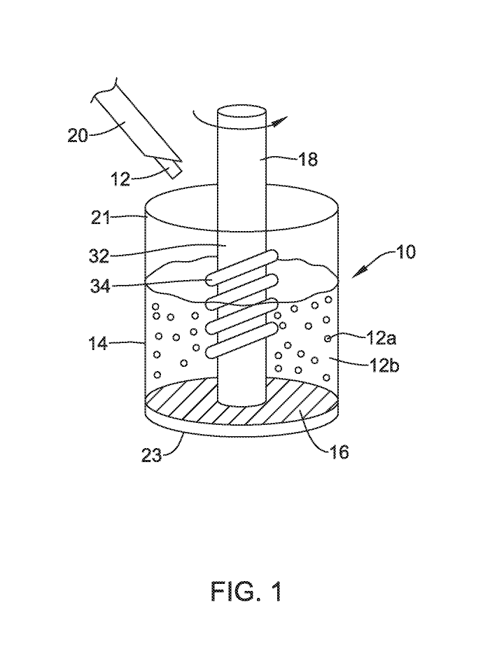

FIG. 1 illustrates an example device 10 for separating a biological sample 12. The device may include a container or vessel 14, a filter membrane 16 disposed within the vessel 14, and a separation or auger member 18 disposed within the vessel 14. In at least some instances, the biological sample 12 may be collected by a fine needle aspiration device 20. Alternatively, the biological sample 12 may be collected by a surgical and/or biopsy device. At least some samples collected by the fine needle aspiration device 20 may include a plurality of loose cells and/or tissue in a body fluid. It may be desirable to separate the sample 12 into a first component 12a (e.g., which may correspond to cells/tissue) and a second component 12b (e.g., which may correspond to the fluid).

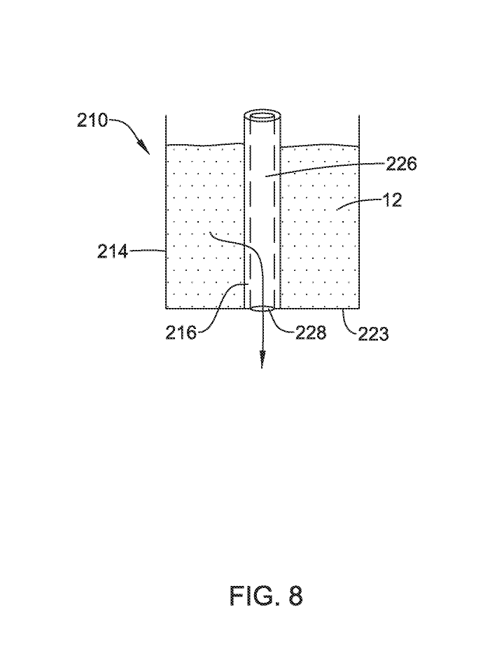

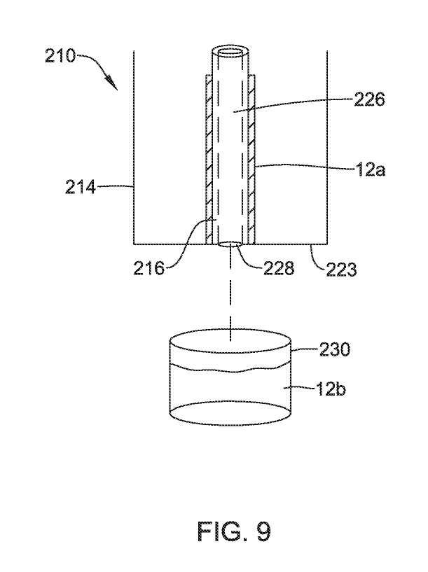

The vessel 14 may vary in form. In some instances, the vessel 14 may take the form of a beaker, flask, tube (e.g., test tube, conical tube, centrifuge tube, or the like), or any other suitable container. A first end region or “top” 21 of the vessel 14 may be open or otherwise include an opening that allows the sample 12 to be transferred into the vessel 14. A second end region or “bottom” 23 of the vessel 14 may be closed, meaning that the bottom 23 of the vessel 14 has a solid wall that can contain the sample 12. In some instances, the vessel 14 may include one or more openings (not shown in FIG. 1 but may resemble the opening 228 shown in FIGS. 8-9) formed in the bottom 23, side wall, or both that allow fluid (e.g., the fluid 12b) to pass through in order to exit the vessel 14.

In at least some instances, the filter membrane 16 may be positioned adjacent to the bottom 23 of the vessel 14. For example, at least a portion of the filter membrane 16 may be disposed along or otherwise in contact with the bottom 23 of the vessel 14. In some instances, the entire filter membrane 16 is disposed along and lines the bottom 23 of the vessel 14. Alternatively, a portion or all of the filter membrane 16 may be spaced from the bottom 23 of the vessel 14. The filter membrane 16 may include a porous material with openings sized to allow the desired cells/tissue 12a to be collected thereon while allowing fluid 12b to pass therethrough. For example, the filter membrane 16 have pores that are about 1-50 microns, or about 1-20 microns, or about 2-10 microns, or about 5 microns, or smaller than about 10 microns, or smaller than about 5 microns, or the like. Alternatively, the filter membrane 16 may be impervious to both the cells/tissue 12a and the fluid 12b.

The auger member 18 may include central shaft 32 and one or more helical threads 34 disposed thereon. The word “auger” in the auger member 18 is not intended to be limiting as other structures are contemplated that may be used in a manner similar to the auger member 18 in order to drive the cells/tissue 12a into contact with the filter membrane 16. For example, the “auger member” 18 may take the form of a plunger or syringe mechanism for driving the cells/tissue 12a into contact with the filter membrane 16.

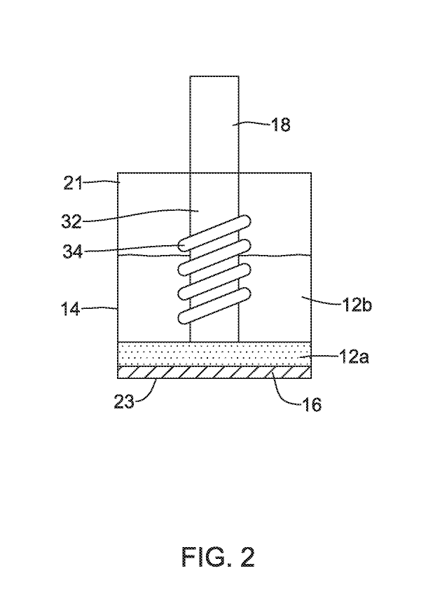

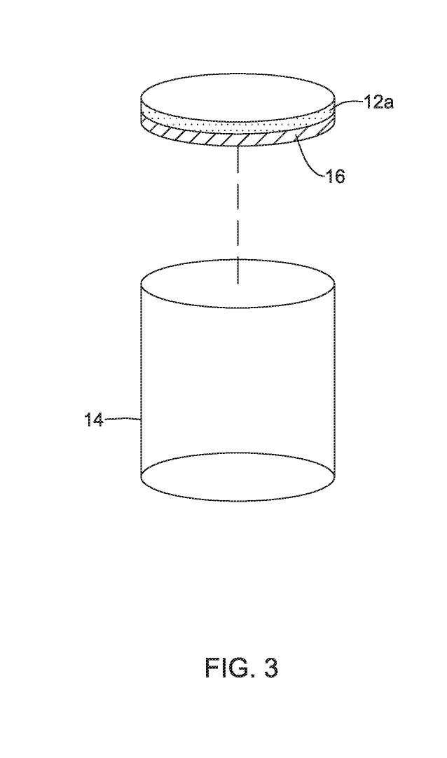

In order to separate the biological sample 12, the biological sample 12 may be transferred from the fine needle aspiration device 20 into the vessel 14. The auger member 18 may be rotated in order to generate a force that drives the cells/tissue 12a into contact with the filter membrane 16 as shown in FIG. 2. This may result in the cells/tissue 12a being coupled to, embedded in, or otherwise securely attached to the filter membrane 16. It is noted that the device 10 and/or the process described herein may allow the cells/tissue 12a to be collected without the use of centrifugation, which may desirably impact the process of gathering the cells/tissue 12a. When the cells/tissue 12a are suitably collected at the filter membrane 16, the auger member 18 as well as the fluid 12b may be removed from the vessel 14. Removing the fluid 12b may include pouring off the fluid 12b, aspirating the fluid 12b from the vessel 14 (using a suitable aspiration device, pipette, or the like), drained from an opening in the bottom or side wall of the vessel 14, or using another suitable technique. With the fluid 12b removed, the filter membrane 16 can be removed from the vessel 14 along with the cells/tissue 12a as depicted in FIG. 3 and the cells/tissue 12a can be further processed. Such further processing may include fixing the cells/tissue 12a (e.g., chemically fixing using a suitable material such as formalin), freezing the cells/tissue 12a, dehydrating the cells/tissue 12a using a suitable material such as ethanol, clearing or otherwise processing the cells/tissue 12a with xylene or another suitable agent, embedding the cells/tissue 12a in a suitable material (e.g., in paraffin or the like), transferring the cells/tissue 12a to a histology cassette, combinations thereof, or the like.

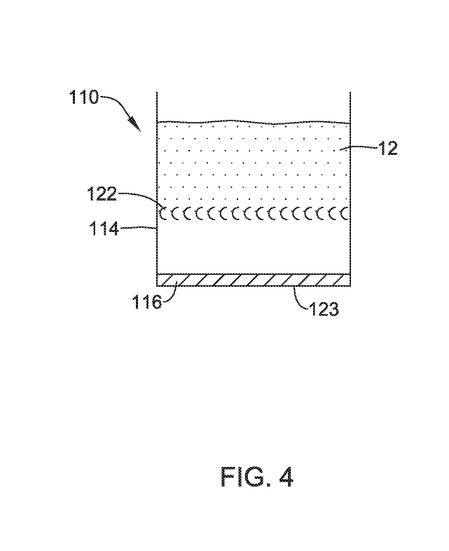

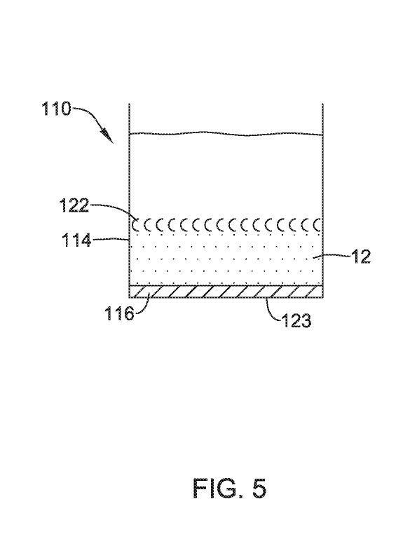

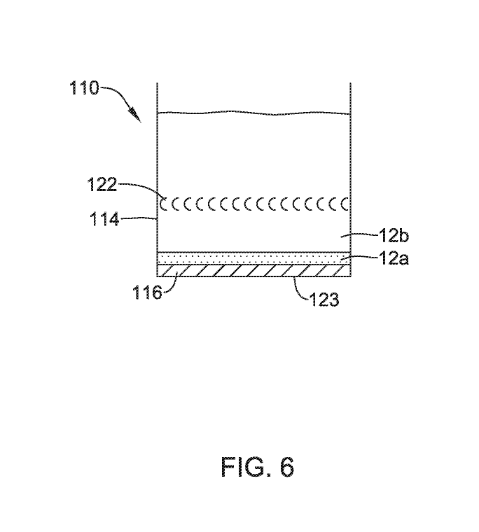

FIG. 4 illustrates another example biological sample separation device 110 that may be similar in form and function to other devices disclosed herein. The device 110 may include a vessel 114 with a filter membrane 116 disposed therein. The device 110 may include a one-way filter 122. The one-way filter 122 may be designed so that when the biological sample 12 is disposed in the vessel 114, the sample 12 can cross the one-way filter 122 in a first direction (e.g., toward the bottom 123 of the vessel 114 in this example) and the sample 12 is substantially prevented from crossing the one-way filter 122 in a second (e.g., opposite) direction as represented in FIG. 5. The one-way filter 122 may take a variety of forms. For example, the one-way filter 122 may include a baffle or other suitable structure. In other instances, the one-way filter 122 may take the form of a membrane that filters in one direction (e.g., which may be similar to how a reverse osmosis membrane operates). The vessel 114 may be centrifuged in order to collect the cells/tissue 12a as shown in FIG. 6. In other instances, centrifugation may not be needed as the biological sample may begin to or otherwise separate due to gravity.

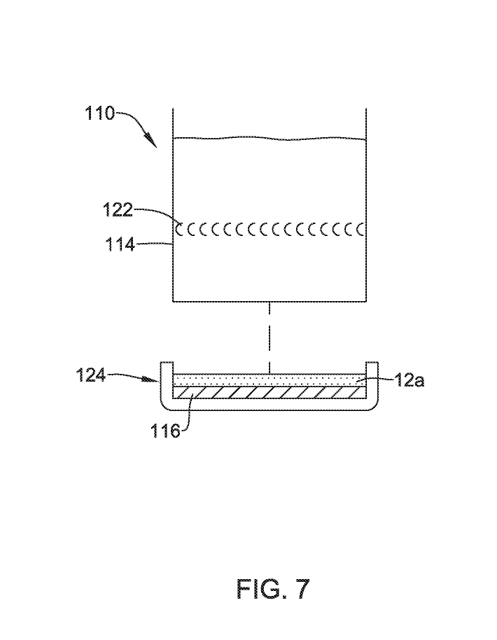

In at least some instances, the vessel 114 may include a tray region 124 that is removable from the vessel 114 as shown in FIG. 7. For example, the tray region 124 may have a surface that extends along the outer surface of the vessel 114 in order to secure the tray region 124 to the vessel 114 by a friction fit. Alternatively, another type of mechanism may be utilized. For example, the tray region 124 may be releasably attached to the vessel 114 by a mechanical fit, adhesive bond, severable connection such as a breakaway tab or perforation, or the like. The tray region 124, which may resemble a petri dish when removed from the vessel 114, may allow a clinician to have more easy access to the cells/tissue 12a. This may aid in processing the cells/tissue 12a.

FIG. 8 illustrates another example biological sample separation device 210 that may be similar in form and function to other devices disclosed herein. The device 210 may include a vessel 214 with a filter membrane 216 disposed therein. In this example, the filter membrane 216 takes the form of a generally cylindrical filter with a central opening 226 formed therein. The opening 226 of the filter membrane 216 may be positioned adjacent to an opening 228 in the vessel 214 (e.g., in the bottom 223 of the vessel 214). The filter membrane 216 may look and function like a sediment filter. Accordingly, the fluid 12b in the sample 12 may be able to flow through the filter membrane 216 (represented by an arrow in FIG. 8) and into the opening 226 while the cells/tissue are collected along the filter membrane 216 as shown in FIG. 9. In some instances, the fluid 12b can flow out of the opening 228 in the vessel and, if desired, may be collected in a suitable container 230.

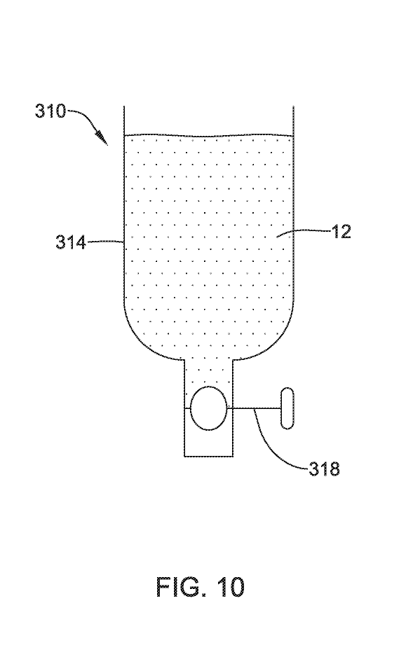

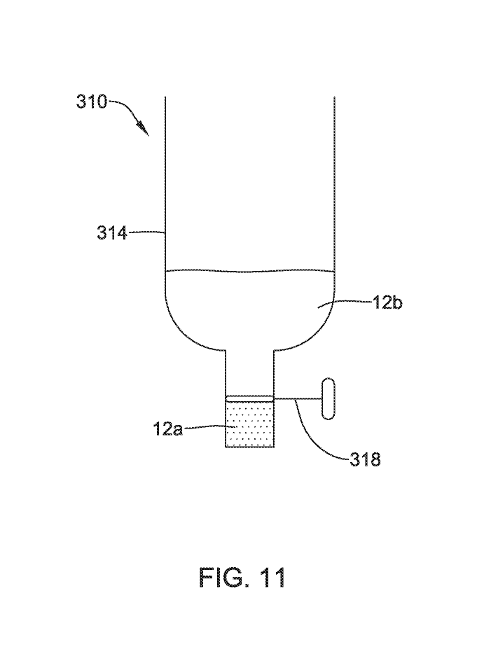

FIG. 10 illustrates another example biological sample separation device 310 that may be similar in form and function to other devices disclosed herein. The device 310 may include a vessel 314 with a barrier member or stopcock 318. The sample 12 may be transferred to the vessel 314 while the stopcock 318 is in a first or open configuration. The vessel 314 may be centrifuged and the cells/tissue 12a may collect near the bottom of the vessel 314 as shown in FIG. 11. With the cells/tissue 12a collected and separated from the fluid 12b, the stopcock 318 can be shifted to a second or closed configuration, thereby capturing the cells/tissue 12a. The cells/tissue 12a can then be collected from the vessel 314. For example, the fluid 12b positioned above the stopcock 318 can be aspirated, poured off, etc. and then the collected cells/tissue 12a can be accessed. Alternatively, a portion of the vessel 314 (e.g., a portion below the stopcock 318) can be removed to provide access to the cells/tissue 12.

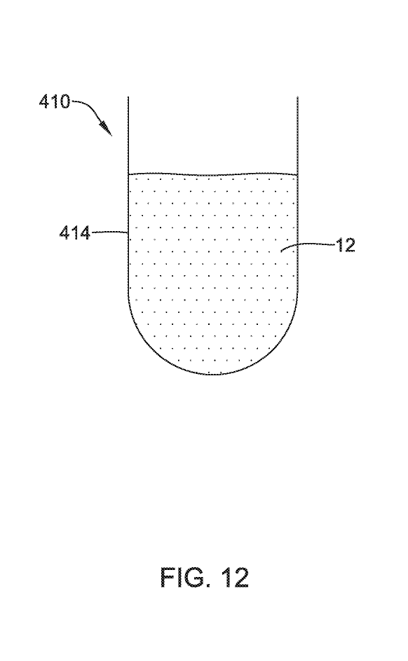

FIG. 12 illustrates another example biological sample separation device 410 that may be similar in form and function to other devices disclosed herein. The device 410 may include a vessel 414. The sample 12 may be transferred to the vessel 414 and the vessel 414 may be centrifuged so that the cells/tissue 12a may collect near the bottom of the vessel 414. With the cells/tissue 12a collected and separated from the fluid 12b, a barrier member 418 can be added to the vessel 414. In this example, the barrier member 418 may take the form of a ball that can be positioned over the cells/tissue 12a. With the ball 418 in place, the fluid 12b can be aspirated, poured off, or otherwise removed from the vessel 414. When the fluid 12b is suitably removed, the cells/tissue 12a can be accessed for further processing.

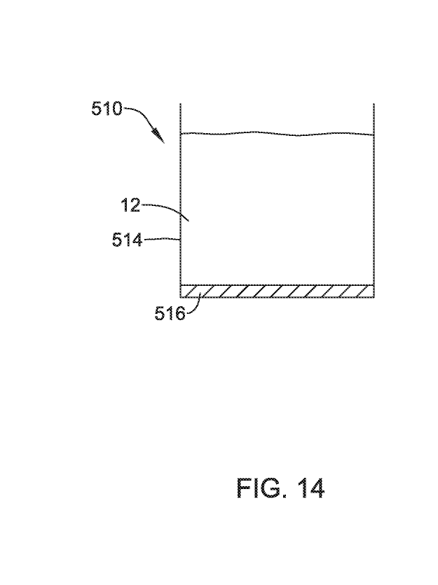

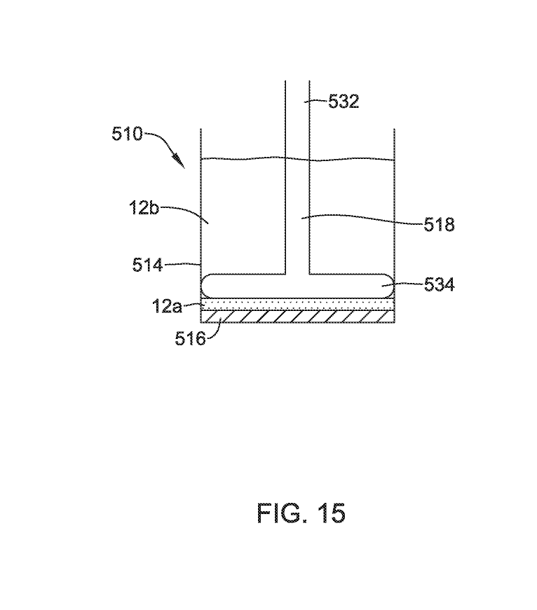

FIG. 14 illustrates another example biological sample separation device 510 that may be similar in form and function to other devices disclosed herein. The device 510 may include a vessel 514. The sample 12 may be transferred to the vessel 514. A separation member 518 may be disposed in the vessel 514. The separation member 518 may include a central shaft 532 and a compression member 534. The compression member 534 may include a filter membrane or otherwise be permeable to fluid. The separation member 518, which may resemble a plunger, may be urged toward the bottom of the vessel 514 as shown in FIG. 15. When doing so, the cells/tissue 12a may collect near the bottom of the vessel 514 and the fluid 12b may pass through the compression member 534. With cells/tissue 12a isolated in the vessel 514, the fluid 12b can be aspirated, poured off, or otherwise removed from the vessel 514. When the fluid 12b is suitably removed, the cells/tissue 12a can be accessed for further processing.

It should be understood that this disclosure is, in many respects, only illustrative. Changes may be made in details, particularly in matters of shape, size, and arrangement of steps without exceeding the scope of the disclosure. This may include, to the extent that it is appropriate, the use of any of the features of one example embodiment being used in other embodiments. The invention's scope is, of course, defined in the language in which the appended claims are expressed.

What is claimed is:

1. A device for separating a sample, the device comprising:
a vessel for holding a sample, the sample includes a plurality of cells;
a filter membrane within the vessel and positioned adjacent to an end region of the vessel; and
an auger member within the vessel, the auger member designed to place the plurality of cells into contact with the filter membrane.

2. The device of claim 1, wherein the vessel includes an open first end region and a second end region positioned substantially opposite the open first end region.

3. The device of claim 2, further comprising a fluid passageway formed along the second end region.

4. The device of claim 1, wherein at least a portion of the filter membrane is positioned against a bottom end surface of the vessel.

5. The device of claim 1, wherein the filter membrane is spaced from a bottom end surface of the vessel.

6. The device of claim 1, wherein the auger member includes a central shaft and a helical thread disposed about the central shaft.

7. The device of claim 1, wherein the auger member is designed to rotate within the vessel.

8. The device of claim 1, wherein the auger member includes a central shaft and a compression member disposed at an end region of the central shaft, wherein the filter membrane is coupled to the compression member.

9. A device for separating a sample, the device comprising:
a vessel for holding a biological sample, the biological sample includes a plurality of cells;
a filter membrane disposed within the vessel, the filter membrane having a first end along a bottom wall surface of the vessel and a second end spaced from the bottom wall surface; and
a one-way filter within the vessel and positioned adjacent to the second end of the filter membrane, the one-way filter designed to allow cells within the biological sample to pass therethrough in a first direction and the one-way filter being designed to prevent cells within the sample to pass therethrough in a second direction opposite the first direction.

10. The device of claim 9, wherein the filter membrane is substantially cylindrical.

11. The device of claim 9, wherein an opening is formed in the vessel along the bottom wall surface.

12. The device of claim 11, wherein at least a portion of the filter membrane extends about the opening.

13. The device of claim 11, wherein the filter membrane extends circumferentially about the opening.

14. The device of claim 9, wherein the one-way filter includes a one-way baffle.

15. The device of claim 9, wherein the one-way filter includes a one-way membrane.

16. The device of claim 9, wherein the vessel includes a removable tray region.

17. The device of claim 16, wherein the bottom wall surface is disposed along the removable tray region.

18. A method for separating a biological sample, the method comprising:
disposing a biological sample within a centrifuge tube, the biological sample includes a plurality of cells and a fluid;
centrifuging the centrifuge tube so that the cells in the biological sample migrate to a bottom wall surface of the centrifuge tube and the fluid within the biological sample is separated from the cells;
disposing a barrier member adjacent to the cells along the bottom wall surface to define a physical barrier between the cells and the fluid; and
removing the fluid.

19. The method of claim 18, wherein the barrier member comprises a stopcock and wherein disposing a barrier member adjacent to the cells along the bottom wall surface to define a physical barrier between the cells and the fluid includes shifting the stopcock from an open configuration to a closed configuration.

20. The method of claim 18, wherein the barrier member comprises a ball member and wherein disposing a barrier member adjacent to the cells along the bottom wall surface to define a physical barrier between the cells and the fluid includes placing the ball member within the centrifuge tube.
